(19) United States
(12) Patent Application Publication
(10) Pub. No.: US 2026/0180335 A1
(43) Pub. Date: Jun. 25, 2026

(54) METHOD AND SYSTEM FOR CONTROLLING ELECTRONIC CONVERTERS

(71) Applicant: INGETEAM POWER TECHNOLOGY, S.A., Zamudio (ES)

(72) Inventors: Roberto GONZÁLEZ SENOSIÁIN, Sarriguren (ES); Julián BALDA BELZUNEGUI, Sarriguren (ES); Manuel NAVARRETE KHIBIT, Sarriguren (ES); Ioseba ERDOCIA ZABALA, Sarriguren (ES); Andoni URTASUN ERBURU, Pamplona (ES); Luis MARROYO PALOMO, Pamplona (ES)

(21) Appl. No.: 18/835,225

(22) PCT Filed: Feb. 10, 2022
(86) PCT No.: PCT/ES2022/070067

§ 371 Date: Aug. 1, 2024

(51) Int. Cl. H02M 1/00; H02M 1/12

(52) U.S. Cl. CPC H02J 3/381; H02J 3/001; H02J 3/11; H02J 3/48; H02J 3/16; H02J 3/388

(57) ABSTRACT

A method for controlling an electronic converter, includes: for each of the phases of the electronic converter, measuring an instantaneous current and an instantaneous voltage of the electronic converter; calculating, from the current measurements and voltage measurements: an active power exchanged by the electronic converter and an effective value of voltage of the electronic converter; calculating an effective value of voltage imposed by the conversion step of the electronic converter. The load angle or a load angle-dependent parameter is obtained from the active power, the effective value of voltage and the effective value of imposed voltage; the frequency of a voltage set-point that must be generated by the electronic converter is calculated from the load angle or the load angle-dependent parameter; and the voltage set-point to be generated by the electronic converter is obtained. A system for controlling an electronic converter to carry out the method is also provided.

### CROSS-REFERENCE TO RELATED APPLICATIONS

This application is a 35 U.S.C. § 371 National Stage patent application of PCT/ES2022/070067, filed on Feb. 10, 2022, the disclosure of which is incorporated herein by reference in its entirety.

### TECHNICAL FIELD

The present disclosure belongs to the field of electronic converters, whether connected to the electricity grid or to isolated systems. More specifically, the disclosure relates to methods and systems for controlling electronic converters.

### BACKGROUND

Today, renewable energies (photovoltaic, wind, etc.) together with energy storage systems (batteries, fuel cells, etc.) constitute an attractive alternative for producing electrical energy in a sustainable way. The energy generated by systems of this type can be used both to power loads isolated from the electricity grid (isolated systems) and to inject it into the electricity grid (grid connection systems). Sometimes these systems can work alternately in one or another mode of operation in the event that the grid connection is not always available.

In general, generation systems (photovoltaic, wind, etc.) and storage systems (batteries, fuel cells, etc.) of this type require DC to AC electronic converters, also called inverters, to be connected to the loads or to the grid.

When connected to isolated systems, i.e., to systems not connected to the grid, the inverters are controlled to behave as voltage sources, contributing to the generation and maintenance of the amplitude and frequency of the alternating voltage generated. On the contrary, in grid connection, inverters have traditionally been controlled as current sources, following the voltage at the connection point to exchange the desired active and reactive powers with the grid. This has been possible since until now synchronous generators (GS) have been mainly responsible for maintaining the amplitude and frequency of the grid voltage. However, the increasing penetration of renewable energy sources and storage systems is causing GS to be replaced by generators connected through inverters. In this scenario, maintaining control of the inverters as current sources could end up compromising the stability of the grid voltage amplitude and frequency. To solve this problem, the inverters must be controlled as voltage sources so that they participate in the maintenance of the grid voltage and frequency.

A widespread method for controlling the amplitude and frequency of the alternating voltage in systems with several inverters connected in parallel working as voltage sources is droop control. This technique makes it possible to guarantee the distribution of active and reactive power between the different generators, according to the capacity thereof, based on the local measurements in each inverter, without requiring communication between them.

Generally, the droop control has parallel control loops, the active power-frequency (P-f) droop and the reactive power-voltage (Q-V) droop, with which the frequency and amplitude of the reference voltage that must be generated by the inverter based on the active and reactive power measurements, respectively, are calculated. The P-f droop is responsible for keeping the inverters synchronised and, at the same time, balancing the distribution of active power. An example of this method is found in the document: “Zhong, Q. C., & Zeng, Y. Universal droop control of inverters with different types of output impedance. IEEE access, 2016, 4, 702-712”.

In isolated systems, the operation of the P-f droop causes the steady-state frequency to vary as a function of the power consumed by the loads connected to the system. To avoid this, the active power-load angle (P-b) droop has been proposed, which directly calculates the difference in angle with the output voltage that the inverter has to generate to exchange the desired active power. An example of this method is found in the document: “B. John, A. Ghosh and F. Zare, Load Sharing in Medium Voltage Islanded Microgrids With Advanced Angle Droop Control, in IEEE Transactions on Smart Grid, vol. 9, no. 6, pp. 6461-6469, November 2018”. However, this technique has the drawbacks of being only valid for isolated systems and requiring fast and precise communication between inverters or the use of GPS synchronisation systems to guarantee the stable behaviour of the system.

These two methods, based on the use of active power as the droop input variable, provide stable behaviour under normal operating conditions, i.e., when the system voltage remains close to the rated voltage and the currents of the inverters do not exceed the rated value thereof. However, in the presence of excess loads, voltage dips or short circuits, the currents exchanged by the inverters could exceed the rated value thereof, which could cause their destruction. To prevent this, inverters controlled as voltage sources include methods for limiting the current (supplied current) to (or below) the maximum value thereof. In this way, in current limitation, the amplitude of the voltage is not controlled and the voltage droop is deactivated. On the contrary, the frequency droop remains active since the inverter must continue imposing the frequency and it thus continues to participate in maintaining the same. In this situation, the output voltage of the inverter decreases, causing the active power to no longer change in the same manner with the overload level of the inverter and may even decrease instead of increase when the overload increases. As a consequence, droop control methods based on active power do not present stable behaviour in current limitation and tend to desynchronise the inverters.

To avoid the problem of desynchronisation in cases of overload, voltage dips or short circuits, some methods proposed in the state of the art include a support PLL (Phase Locked Loop) to control the frequency in these situations. An example of this method is found in the document “Shi, K., Song, W., Xu, P., Liu, R., Fang, Z., & Ji, Y. Low-voltage ride-through control strategy for a virtual synchronous generator based on smooth switching. IEEE Access, 2017, 6, 2703-2711”. However, the use of the support PLL causes the inverters to stop contributing to the maintenance of the system frequency and, in addition, has stability problems in certain line impedance ranges, as reflected in the document “Hu, Qi, et al. Large signal synchronizing instability of PLL-based VSC connected to weak AC grid. IEEE Transactions on Power Systems, 2019, vol. 34, no. 4, p. 3220-3229”.

To reduce the influence of the voltage on the variable with which the frequency droop is performed, the use of the active current (I_{active}-f droop) has been proposed. This variable is obtained by dividing the active power by the amplitude of the voltage at the inverter output. Using the I_{act}-f droop, a behaviour similar to that of the P-f droop is achieved under normal operating conditions, and it improves the behaviour in the event of overloads and shallow voltage dips. An example of this method is found in the document “Brabandere, K. D., Bolsens, B., Keybus, J. V., et al.: ‘A voltage and frequency droop control method for parallel inverters’, IEEE Trans. Power Electron., 2007, 22, (4), pp. 1107-1115”. However, by limiting the current, an increase in the overload does not translate into an increase in the active current, but rather it stays practically constant, which does not guarantee that the inverters remain synchronised under any operating condition, such as deep voltage dips or short circuits.

### SUMMARY

The present disclosure provides a method and a system that aim to solve the drawbacks of the methods and systems described in the state of the art. The present disclosure provides a method and a system for controlling an electronic converter connected to an isolated system (for example, to one or more loads) or to the electricity grid. To perform this control, the method calculates, based on the load angle of the electronic converter or on a load angle-dependent parameter, the frequency of a voltage set-point that must be generated by the electronic converter. The method is applicable to electronic converters connected in parallel, whether to isolated systems (for example, loads) or to the electricity grid.

In the context of the present disclosure, the terms “electronic converter” and “inverter” are used interchangeably. The electronic converter can be single-phase or three-phase.

Obtaining the frequency of the voltage set-point is based on the droop concept. Thus, the frequency of the voltage set-point is determined by applying a frequency droop control using the load angle (or a load angle-dependent parameter) directly as input variable, which is the phase shift between the voltage imposed by the electronic converter before the output filter and the voltage at the filter output, instead of using the active power or active current, as is performed in the state of the art. This variable represents the phase shift between the electronic converter and the system (the electricity grid and/or isolated systems), both under normal conditions, wherein the voltages present values close to the rated (nominal) value, and in the presence of excess loads, voltage dips or short circuits, wherein the amplitude of the voltages decreases, for example, due to the actuation of a current limiting method.

The method and system are applicable, among others, to DC/AC (Direct Current/Alternating Current) electronic converters or to DC/DC+DC/AC electronic converters.

The converters can be connected in parallel with the electricity grid or to a system of loads isolated from the grid, either independently or with several converters in parallel.

The proposed control method is especially applicable in inverters controlled as a voltage source. The method can be applied, among others, to inverters controlled as a voltage source that also implement a current limiting method. In each execution period, the proposed control method determines the frequency of the voltage or voltages (voltage set-point) that the electronic converter must impose from the load angle (δ) or a variant of the same, using a load angle-frequency droop (δ-f droop). To obtain the amplitude of the voltages that the electronic converter must impose, any of the existing methods of the state of the art can be used. In this way, the electronic converter is controlled at the output thereof as an alternating voltage source.

In a first aspect of the disclosure, a method for controlling an electronic converter is provided. The method comprises the steps of: for each of the phases of the electronic converter, measuring an instantaneous current and an instantaneous voltage of the electronic converter; calculating, from the current measurements and voltage measurements: an active power exchanged by the electronic converter and an effective value of voltage of the electronic converter; and calculating an effective value of voltage imposed by the conversion step of the electronic converter. The method further comprises: obtaining the load angle or a load angle-dependent parameter from the active power, the effective value of voltage and the effective value of imposed voltage; calculating the frequency of a voltage set-point that must be generated by the electronic converter from the load angle or on the load angle-dependent parameter; obtaining the voltage set-point that must be generated by the electronic converter from the calculated frequency.

The method calculates the frequency of the voltage set-point that must be generated by the electronic converter from the load angle of the electronic converter, or from a load angle-dependent parameter. This variable directly represents the phase shift of each electronic converter with the system regardless of the operating conditions.

In embodiments of the disclosure, the frequency of the voltage set-point that must be generated by the electronic converter is obtained by applying a frequency droop to the load angle or to the load angle-dependent parameter.

In embodiments of the disclosure, the load angle or load angle-dependent parameter is filtered before applying the frequency droop.

In embodiments of the disclosure, the applied frequency droop follows a linear function.

In embodiments of the disclosure, the measured voltage has been measured at the terminals of a capacitor of an output filter of each phase of the electronic converter. Alternatively, the measured voltage has been measured at the output of the electronic converter. Alternatively, the measured voltage has been obtained by measuring the line voltage.

In embodiments of the disclosure, the load angle or load angle-dependent parameter is obtained from the following equation:

$${P}_{n} = \frac{{E}_{n} \cdot {V}_{n}}{{\vert {\vec{Z}}_{n} \vert}^{2}} \cdot {X}_{n} \cdot sin ( {δ}_{n} ) + \frac{{V}_{n}}{{\vert {\vec{Z}}_{n} \vert}^{2}} \cdot {R}_{n} \cdot ( {E}_{n} \cdot cos ( {δ}_{n} ) - {V}_{n} )$$

wherein Pₐ is the active power exchanged by the electronic converter, Vₙ is the effective value of voltage of the electronic converter, Eₙ is the effective value of voltage imposed by the conversion step of the electronic converter and \vec{Zₙ}=Rₙ+j Xₙ is the impedance of the filter of the electronic converter.

In embodiments of the disclosure, the load angle or load angle-dependent parameter is obtained from the following equation:

$${P}_{n} = \frac{{E}_{n} \cdot {V}_{n}}{{X}_{n}} \cdot sin ( {δ}_{n} )$$

wherein Pₐ is the active power exchanged by the electronic converter, Vₙ is the effective value of voltage of the electronic converter, Eₙ is the effective value of voltage imposed by the conversion step of the electronic converter and Xₙ is the reactance of the filter of the electronic converter.

In embodiments of the disclosure, a voltage droop is also included in addition to the aforementioned frequency droop, which also intervenes in the calculation of the voltage set-point(s), to obtain an amplitude of said set-point(s). A conventional voltage droop can be used to calculate the amplitude of the voltage set-point(s) that must be generated by the electronic converter. In this way, the voltage set-point(s) is/are obtained from the frequency and from this amplitude value. For example, the voltage droop can be performed with both the reactive power variable, Q, and the reactive current variable, I_{react}, as proposed in the state of the art.

In embodiments of the disclosure, the method further comprises, once the voltage set-point is obtained, applying a voltage control step to determine a voltage that the electronic converter must impose to achieve that voltage set-point. The voltage control step may implement, for example, a voltage control in alpha and beta axes, or a voltage control in dq axes, or an open-loop voltage control.

In embodiments of the disclosure, the method further comprises a complementary current limiting step, which is preferably applied at the output of the voltage control, for which any of the existing methods of the state of the art can be used.

In embodiments of the disclosure, the method further comprises correcting the load angle or the load angle-dependent parameter, to compensate for the phase shift introduced by the current limitation between the voltage set-point and the voltage imposed by the electronic converter.

In embodiments of the disclosure, the method further comprises correcting the load angle or the load angle-dependent parameter, to compensate for any possible phase shift between the voltage set-point and the voltage imposed by the electronic converter.

In embodiments of the disclosure, the function used to calculate the frequency of a voltage set-point may be predetermined or may be dynamically modified by an external control unit.

In embodiments of the disclosure, the method is applied to a plurality of electronic converters connected in parallel.

In embodiments of the disclosure, the method is applied to one or more single-phase electronic converters. Alternatively, the method is applied to one or more three-phase electronic converters.

In embodiments of the disclosure, the method is repeated at moments in time that are marked according to a clock frequency.

A second aspect of the disclosure provides a system for controlling an electronic converter to carry out the method according to the first aspect of the disclosure. The control system comprises: means for measuring an instantaneous current and an instantaneous voltage of the electronic converter; means for: calculating, from the current measurements and voltage measurements: an active power exchanged by the electronic converter and an effective value of phase voltage of the electronic converter; calculating an effective value of voltage imposed by the conversion step of the electronic converter; obtaining the load angle or a load angle-dependent parameter from the active power, the effective value of voltage and the effective value of imposed voltage; calculating the frequency of a voltage set-point that must be generated by the electronic converter from the load angle or on the load angle-dependent parameter; and obtaining the voltage set-point that must be imposed on the electronic converter from said frequency.

In embodiments of the disclosure, the control system further comprises a voltage controller.

In embodiments of the disclosure, the control system further comprises a current controller.

The method and system for controlling electronic converters guarantee that the electronic converters remain synchronised both under normal operating conditions and in the presence of excess loads, voltage dips or short circuits, without requiring the introduction of communication means (input/output interfaces, transmitters/receivers, antennas, etc.) between the electronic converters.

The method for controlling an electronic converter of the disclosure is performed in a plurality of time instants. Said time instants relate, in the present description, to each sampling operation according to a frequency, i.e., to clock ticks or pulses. In general, the sampling frequency falls within the usual ranges of controllers used in systems for controlling inverters, for example, at the switching frequency of the converter or multiples or sub-multiples thereof. That is, the control method or algorithm is executed periodically.

The execution period can take a value in the range between 1 and 100,000 μs (microseconds, 10⁻⁶ seconds), such as a value between 10 and 50,000 μs, or between 10 and 10,000 μs, or between 10 and 2,000, or between 50 and 1,200, or between 50 and 200 μs, or between 80 and 150 μs. For example, it runs once every 1,000 μs (1 ms).

In each execution period, the droop control calculates the frequency (and, if applicable, the amplitude) of the voltage set-point(s) and, based on the frequency and amplitude, the voltage set-points that must be generated by the electronic converter are obtained. Once the voltage set-point or set-points have been obtained, a voltage control step can be applied to determine a voltage that the electronic converter must impose on each phase (i.e., whether it is single-phase or three-phase) to achieve that voltage set-point. In the event that the current approaches or exceeds a maximum value, the voltages imposed by the electronic converter before the filter may optionally be modified by a current limiting method.

Thus, the proposed method has the following advantages:
Under normal operating conditions, the operation of the δ-f droop enables the converters to remain synchronised and the distribution of active load between them occurs based on the capacity thereof.
In excess loads, voltage dips or short circuits, the load angle δ increases in the same way as under normal operating conditions. This feature guarantees that the electronic converters remain synchronised under any operating condition. This does not happen with the P-f droop and the I_{act}-f droop, because the active power, P, and the active current, I_{act}, depend on the amplitude of the voltages and, therefore, are not representative of the overload level when the current limitation acts.
The electronic converters remaining synchronised in the presence of excess loads, voltage dips or short circuits, something that is guaranteed with the δ-f droop, enables rapid voltage recovery when the electronic converters return to normal operating conditions.
The introduction of a support PLL is not required because in any situation, including excess loads, voltage dips or short circuits, the 6-f droop ensures the synchronisation of the inverters.

These and other advantages and features of the disclosure will become apparent in light of the figures and the detailed description of the disclosure.

### BRIEF DESCRIPTION OF THE DRAWINGS

FIG. 1A shows a connection diagram of a single-phase electronic converter, the input of which can be an energy source or a storage system and at the output thereof it is connected, through an output filter, to the main electricity grid or to a load.

FIG. 1B shows a connection diagram of several single-phase electronic converters like the one in FIG. 1A, connected in parallel.

FIG. 1C shows a connection diagram of a three-phase electronic converter, the input of which can be an energy source or a storage system and at the output thereof it is connected, through an output filter, to the main electricity grid or to one or more loads.

FIG. 2 shows the single-phase equivalent circuit of the impedance of the filter of an electronic converter according to FIGS. 1A-1C and a phasor representation of the currents and voltages.

FIG. 3A shows a block diagram corresponding to obtaining, by applying a frequency droop control, the frequency of a voltage set-point that must be generated by an electronic converter, according to one embodiment of the disclosure.

FIG. 3B shows a block diagram corresponding to obtaining, by applying a frequency droop control, the frequency of a voltage set-point that must be generated by an electronic converter, according to another embodiment of the disclosure.

FIG. 4 shows a block diagram representing a method for controlling an electronic converter, according to embodiments of the disclosure.

FIG. 5 shows a block diagram corresponding to the frequency droop control performed with the active power variable (P-f droop) of the state of the art.

FIG. 6 shows a block diagram corresponding to the frequency droop control performed with the active current variable (I_{act}-f droop) of the state of the art.

FIG. 7 shows the simulation results of a P-f droop control of the state of the art, in the event of an overload of 10%.

FIG. 8 shows the simulation results of an I_{act}-f droop control of the state of the art, in the event of an overload of 10%.

FIG. 9 shows the simulation results of the method with the 6-f droop of the disclosure, in the event of an overload of 10%.

FIG. 10 shows the simulation results of a P-f droop control of the state of the art, in the event of a three-phase short circuit with short circuit voltage U_{DC}=10%.

FIG. 11 shows the simulation results of an I_{act}-f droop control of the state of the art, in the event of a three-phase short circuit with short circuit voltage U_{DC}=10%.

FIG. 12 shows the simulation results of the method with the sin(δ)-f droop control of the disclosure, in the event of a three-phase short circuit with short circuit voltage U_{DC}=10%.

### DETAILED DESCRIPTION OF THE DRAWINGS

The control method of the disclosure is especially adapted for controlling an electronic converter, such as a DC/AC converter, as a voltage source. The electronic converter may be working in parallel with other electronic converters and/or power generators. The electronic converter can be connected at the output thereof to the main electricity grid, to a load (for example, in the case of a single-phase converter) or to a set of isolated loads (for example, in the case of a three-phase converter).

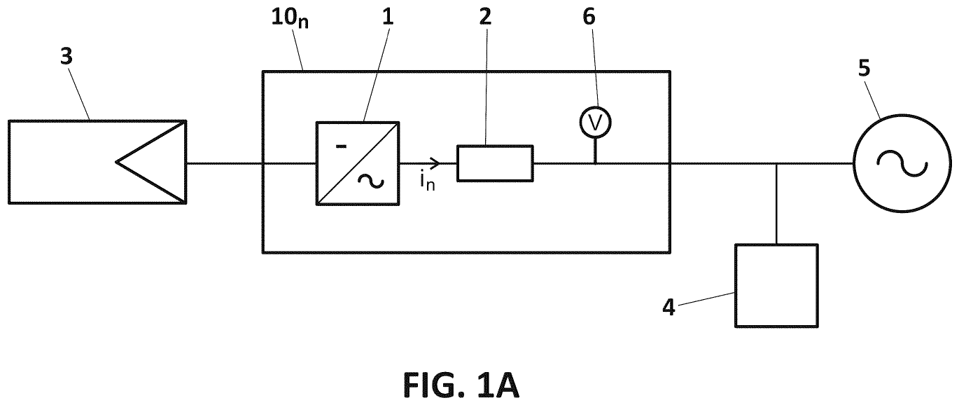

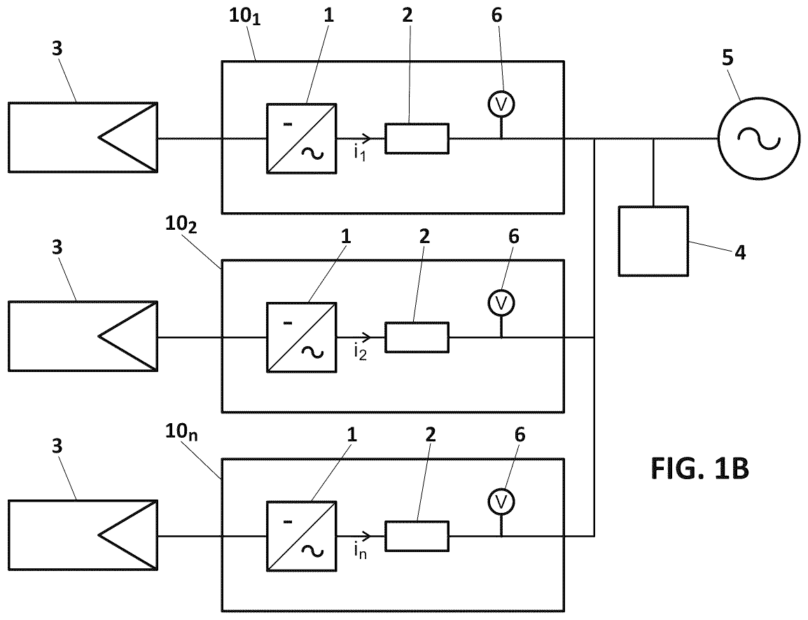

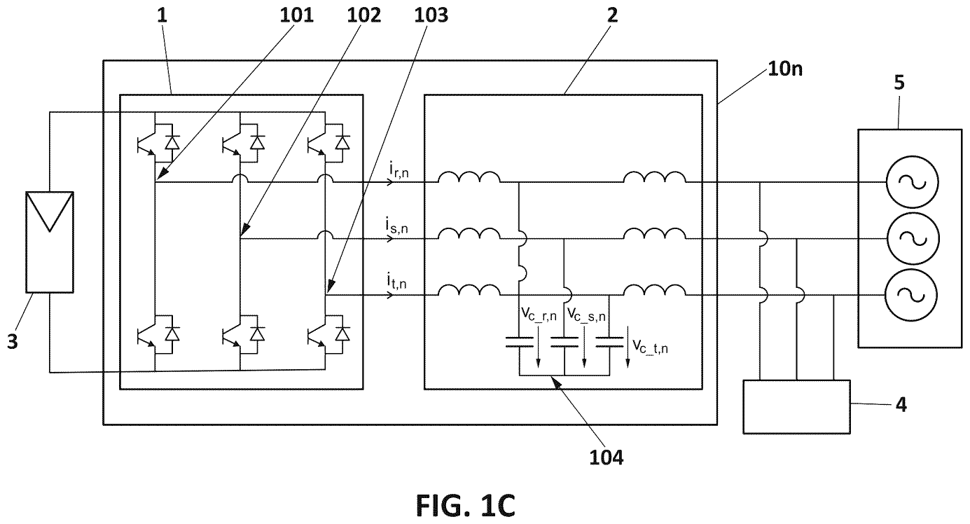

FIG. 1A shows a connection diagram of an electronic converter 10ₙ, (in FIG. 1A, n=1) specifically of a DC/AC electronic converter. The connection diagram shown corresponds to the phase of a single-phase converter. The electronic converter 10ₙ has been schematically represented as two blocks 1, 2. Block 1 represents the conversion step, which is conventional and falls outside the scope of the present disclosure. Block 2 represents the output filter, which can be an LCL filter, an LC filter or any other conventional variant. The output filter 2 is intended to filter switching harmonics. The input 3 of the converter 10ₙ can be an energy source (for example, a continuous energy source) or a storage system. If it is an energy source, it can be of different types, such as a renewable generation source (photovoltaic solar or wind, for example). If it is a storage system, it can be a battery, a fuel cell or a capacitor bank, for example. The output of the converter 10ₙ, through the output filter 2, is connected to the electricity grid 5 (for example, to the main electricity grid) or to a load 4. Between the converter 10ₙ (specifically, the output step 2) and the load 4 or the electricity grid 5 there may be a transformer, not shown in FIG. 1A.

The electronic converter 10ₙ may be working in parallel with other electronic converters and/or power generators. FIG. 1B shows a connection diagram of several electronic converters 10₁ . . . 10ₙ in parallel like the one in FIG. 1A.

FIG. 1C shows a connection diagram of an electronic converter 10ₙ, (in FIG. 1C, n=1) specifically of a DC/AC electronic converter, which in this case is a three-phase converter. The same reference numbers as in FIGS. 1A-1B have been used to indicate the same elements. To show the three-phase converter, both a possible implementation of the conversion step 1 and of the output filter 2 have been schematically detailed. As in FIG. 1A, the input 3 of the converter 10ₙ can be an energy source (for example, a continuous energy source) or a storage system. If it is an energy source, it can be of different types, such as a renewable generation source (photovoltaic solar or wind, for example). If it is a storage system, it can be a battery, a fuel cell or a capacitor bank, for example. The output of the converter 10ₙ, through the output filter 2, is connected to the electricity grid 5 (for example, to the main electricity grid) or to several loads (for example, one per phase). In FIG. 1C, the output filter 2 is an LCL filter, but an LC filter or any other variant could alternatively be used. Between the converter 10ₙ (specifically, the output step 2) and the load(s) 4 or the electricity grid 5 there may be a transformer, not shown in FIG. 1C. The three-phase electronic converter 10ₙ of FIG. 1C may be working in parallel with other electronic converters and/or power generators. For conciseness, this possibility has not been illustrated, but a skilled person will understand that the connection diagram thereof is similar to that of FIG. 1B.

The method of the disclosure implements a control of the voltage generated by the electronic converter 10ₙ. The control method is executed at all times and, in the event of several converters 10₁ . . . 10ₙ (FIG. 1B), in parallel between them. Specifically, the control method is applied to the phase (or phases) of the conversion step 1 of the one or more electronic converters 10ₙ.

In implementations where the output filter 2 is an LCL filter, the output voltage of the converter 10ₙ (i.e., after the filtering step 2) can be both the voltage measured at the terminals of the capacitor of the output filter2 (V_{C_r,n}, V_{C_s,n}, V_{C_t,n} in FIG. 1C), and the voltage in the grid 5 or load (loads) 4, or the voltage measured in the line, as represented in FIGS. 1A-1B through the voltmeter 6. This is applicable to both single-phase and three-phase converters. In the event that the output filter 2 of the phase (or phases) is an LC filter, not illustrated, the voltage measured at the output (in the grid 5 or load(s) 4) is the same as the voltage measured at the terminals of the capacitator of the LC filter.

At each instant, the control method calculates the voltage set-points that should be generated in each phase (if the converter is three-phase) or in the phase (if the converter is single-phase) by the electronic converter 10ₙ so that said phase behaves as an alternating voltage source with certain amplitude and frequency values, i.e., those desired depending on the load, the loads or the grid to which the converter is going to be connected.

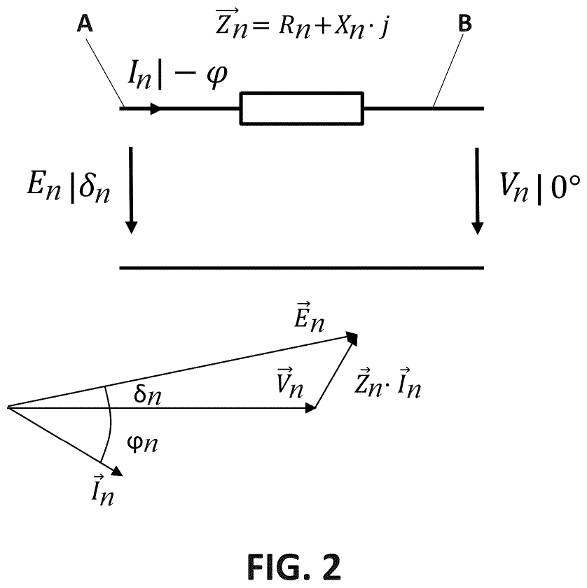

FIG. 2 shows the single-phase equivalent circuit of the impedance of the filter 2 of each electronic converter 10ₙ and a phasor representation of currents and voltages. In other words, the point indicated as “A” in FIG. 2 corresponds to the output of the conversion step 1 of a converter 10ₙ (or input of the filtering step 2), and the point indicated as “B” in FIG. 2 corresponds to the output of the filtering step 2 of a converter 10ₙ. The filter impedance \vec{Zₙ} of each electronic converter 10ₙ can be represented as shown in FIG. 2, \vec{Zₙ}=Rₙ+j Xₙ, wherein the real portion is the filter resistance Rₙ and the imaginary portion is the filter reactance Xₙ. FIG. 2 also shows: the effective value of the voltage Eₙ imposed by the conversion step 1 before the filter 2 (for example, in FIG. 1C, effective value e_{r,n} between the point 101 and the neutral 104, effective value e_{s,n} between the point 102 and the neutral 104, and effective value e_{t,n} between the point 103 and the neutral 104); the effective value of the current Iₐ of the converter (current iₙ in FIG. 1A, current i₁, i₂, . . . iₙ in FIG. 1B, current i_{r,n}, i_{s,n}, . . . i_{t,n} in FIG. 1C); and the effective value Vₙ of the output voltage of the converter 10ₙ. In the equivalent circuit of FIG. 2, the angle φₙ is also mentioned, which expresses the phase shift between the current and output voltage of the converter, and the load angle δn, which represents the phase shift of the voltage of each electronic converter 10ₙ with that of the system. Thus, at the input “A” the vector of the voltage imposed by the converter Eₙ with a given loading angle δn is expressed, compared to the output “B”, in which the vector of the output voltage Vₙ is expressed, considering this vector as an angle reference.

The lower portion of FIG. 2 shows the vectors: voltage imposed \vec{Eₙ} by the converter 10 before the filter 2 (i.e., at the output of conversion step 1), output voltage of the converter \vec{Vₙ} and current of the converter \vec{Iₙ}. It can be seen that the load angle δₙ represents the angle between the voltage imposed \vec{Eₙ} by the conversion step 1 and the output voltage \vec{Vₙ}.

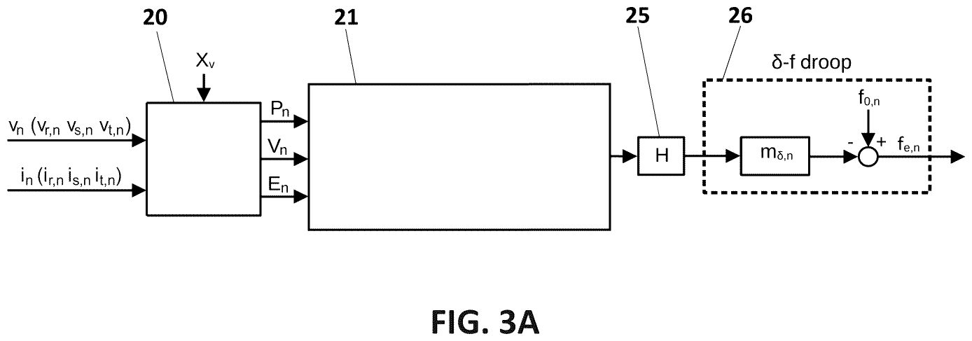

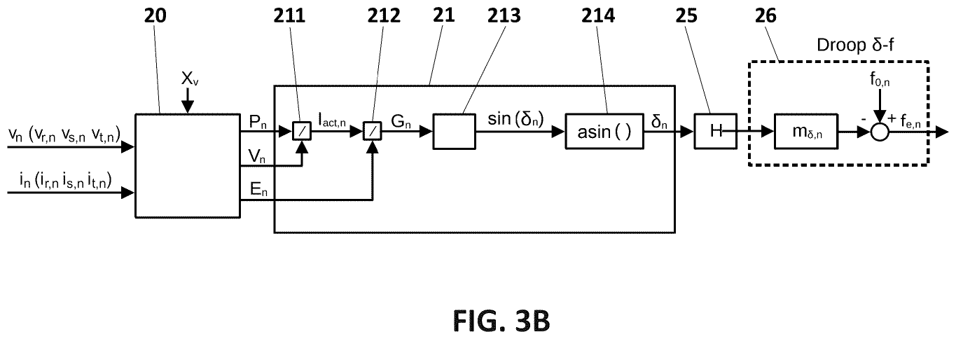

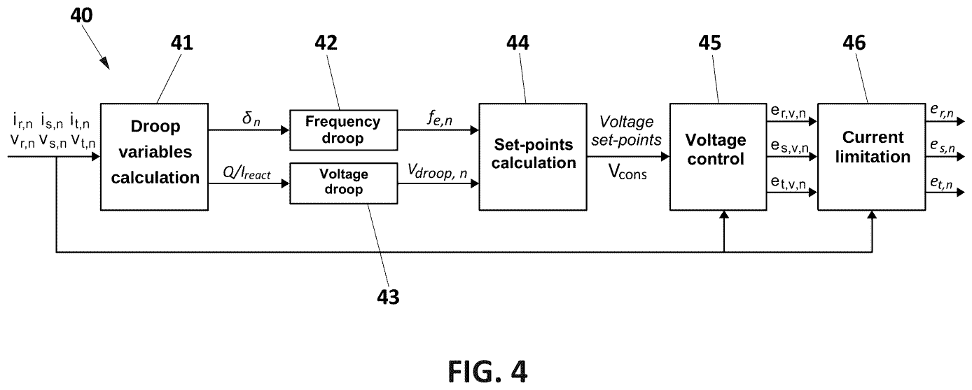

The proposed method for controlling an electronic converter 10ₙ comprises a step of calculating the frequency of a voltage set-point that must be generated by the electronic converter. The proposed method for determining this frequency is outlined in FIGS. 3A-3B. The frequency of the voltage set-point is obtained by applying a frequency droop using the load angle variable δ or a load angle-dependent parameter δ (δ-f droop). The proposed method or frequency droop control is subsequently used to obtain the voltage set-point (in the case of a single-phase converter) or set-points (in the case of a three-phase converter) that must be generated by the electronic converter. Once the voltage set-point(s) has been obtained, a voltage control can be applied to determine the voltage (one per phase, in the case of a three-phase converter) that the converter must impose to achieve that voltage set-point. The complete control is schematised as an example in FIG. 4.

Under normal operating conditions, the effective value of the voltage Eₙ imposed by the converter and the effective value of the output (or phase) voltage of the converter Vₙ hardly vary in amplitude over many time cycles. However, in current limiting situations, Eₙ and Vₙ decrease (they no longer maintain their amplitude substantially constant overtime). This causes, in such circumstances, that the power exchanged by the converter Pₙ decreases instead of increases. That is, under current limiting circumstances (for example, overload), the exchanged power Pₐ is not representative because it does not create a sensation of overload.

For this reason, obtaining the frequency of the voltage set-point from a variable that does not depend on the voltage Eₙ imposed by the converter or on the output voltage of the converter Vₙ is proposed. Specifically, obtaining the frequency of the voltage set-point that must be generated by the electronic converter (frequency that is obtained using a method or droop control) from the load angle δₙ, or from a parameter dependent on the same, is proposed. This ensures the correct reaction of the electronic converter to changes in any operating mode.

Therefore, to determine the frequency of the voltage set-point, it is necessary to obtain the load angle δ, or a load angle-dependent parameter δ, which represents the phase shift of the electronic converter 10 with the system to which it is connected at the output thereof (i.e., with the electricity grid 5 or the load or loads 4). With the load angle δ, or alternatively with a parameter dependent on the same, the frequency droop (δ-f droop) will subsequently be carried out to obtain the frequency of the voltage set-point.

FIG. 3A shows a general block diagram for obtaining the reference frequency for a converter “n”. First, the current in of the converter 10ₙ (current i delivered by conversion step 1) and the output voltage vₙ of the converter 10ₙ are measured. In FIG. 1A, the current of the converter 10ₙ has been represented as iₙ, while in FIG. 1B, it has been represented as i₁ . . . iₙ for the n converters represented, and in FIG. 1C, it has been represented as i_{r,n}, i_{s,n}, i_{t,n} for each of the phases of a three-phase converter. In FIGS. 1A-1C, the output voltage of the converter 10ₙ can be, as explained, the voltage measured at the terminals of the capacitor of the output filter 2 (V_{C_r,n}, V_{C_s,n}, V_{C_t,n} in FIG. 1C), or the voltage at the output of the converter as represented in the figures through the voltmeter 6. In general, in FIG. 3A, the measured current and voltage have been represented as “iₙ” and “vₙ”. A person of average skill understands that for a three-phase “n” converter, the currents of each phase (i_{r,n} i_{s,n} i_{t,n}) and the output voltages of each phase (v_{r,n} v_{s,t} v_{t,n}) or their line equivalents are measured.

Once the instantaneous current in and the instantaneous voltage vₙ of the converter 10ₙ (or the currents of the three phases i_{r,n} i_{s,n} i_{t,n} and the output voltages of each phase v_{r,n} v_{s,t} v_{t,n}) have been measured, in a first step (block 20), from the measured current and voltage: the active power Pₙ exchanged by the electronic converter 10ₙ and an effective value of voltage Vₙ at the output of the electronic converter 10ₙ, are calculated. For calculations of the exchanged active power Pₙ and the effective value of voltage Vₙ, conventional techniques are used, known to a person of average skill, which fall outside the scope of the present disclosure.

In addition, an effective value of voltage Eₙ imposed by conversion step 1 is calculated. For the calculation of the effective value of imposed voltage Eₙ, conventional techniques are used, known to a person of average skill, which fall outside the scope of the present disclosure. For example, the effective value of imposed voltage Eₙ can be obtained from the values applied in a previous cycle of the converter control or, in the event of using a PWM modulation, calculated from the DC voltage (not illustrated) and from the relationship between the modulation and the peak value of the triangle.

Instantaneous measurements of voltage vₙ and current iₙ can be filtered before being used for the various calculations. The filter used can be implemented both in an analogue and a digital manner. By way of example, the filter may be high pass, low pass, or a combination of both. This filtering is not illustrated (it is generally included in block 20).

Next, from the calculated values of exchanged active power Pₙ, effective value of voltage Vₙ and effective value of imposed voltage Eₙ, either the load angle δₙ, or a load angle-dependent parameter δₙ are obtained (block 21 of FIG. 3A). With the load angle δₙ, or alternatively with a parameter dependent thereon, the frequency droop (δ-f droop) (block 26) will subsequently be carried out.

A possible manner of obtaining the load angle δₙ or a parameter dependent thereon is described below. The load angle δₙ of an electronic converter n can be calculated from the power Pₙ exchanged through the impedance \vec{Zₙ} of the filter 2. The power Pₙ exchanged through the impedance \vec{Zₙ} can be expressed as:

$${P}_{n} = \frac{{E}_{n} \cdot {V}_{n}}{{\vert {\vec{Z}}_{n} \vert}^{2}} \cdot {X}_{n} \cdot sin ( {δ}_{n} ) + \frac{{V}_{n}}{{\vert {\vec{Z}}_{n} \vert}^{2}} \cdot {R}_{n} \cdot ( {E}_{n} \cdot cos ( {δ}_{n} ) - {V}_{n} ) . \qquad ( 1 )$$

Note that the values of exchanged active power Pₙ, effective value of voltage Vₙ and effective value of imposed voltage Eₙ have been previously calculated. Therefore, the power flowing at the output of the converter or, in other words, transferred by the converter or exchanged by the converter depends on the effective values of voltage Eₙ and Vₙ, on the impedance Z and on the load angle δₙ. Therefore, it is possible to obtain the load angle δₙ of the converter “n” from formula (1) and from the previous calculations made.

After obtaining the load angle δₙ, a filtering step 25 can optionally be applied. For example, a low pass filter can be applied. After optional filtering, from the load angle δₙ a method or frequency droop control (δ-f droop) can be applied (step 26) to obtain the frequency of the voltage set-point f_{e,n} which must be generated by the electronic converter.

Sometimes the output impedance of the converter \vec{Zₙ} is very inductive, for example, due to the character of the line or the emulation of a virtual inductance at the output. For example, it is possible to emulate a virtual impedance in the calculation of the voltage set-points to guarantee the inductive nature of the output impedance of the electronic converter. On these occasions it can be considered that the real portion of the impedance (the resistance Rₙ) is practically zero. In this case, the formula (1) of the power Pₙ exchanged by each electronic converter 10ₙ can be simplified as:

$${P}_{n} = \frac{{E}_{n} \cdot {V}_{n}}{{X}_{n}} \cdot sin ( {δ}_{n} ) . \qquad ( 2 )$$

Therefore, the power flowing at the output of the converter or, in other words, transferred by the converter or exchanged by the converter depends on the effective values of line voltage Eₙ and Vₐ, on the output reactance Xₙ and on the load angle δₙ. FIG. 3B shows a block diagram of an alternative manner of obtaining the reference frequency in a converter 10ₙ in the particular case that the output impedance of the converter \vec{Zₙ} is very inductive. In this case, it is possible to obtain either the load angle δₙ, or a load angle-dependent parameter δₙ, such as the sine of the loading angle δₙ or the conductance of the converter 10ₙ.

Thus, from the previous equation (2), the estimated load angle δ_{n,est} is obtained:

$${δ}_{n , est} - arcsin ( \frac{{P}_{n} \cdot {X}_{n}}{{E}_{n} \cdot {V}_{n}} ) \approx {δ}_{n , real} , \qquad ( 3 )$$

The load angle obtained is an estimated load angle δ_{n,est} because it has been assumed that the output impedance of the converter \vec{Zₙ} is very inductive (resistance Rₙ is practically zero). Under the aforementioned conditions, the estimated load angle δ_{n,est} is approximately equal to the real load angle δ_{n,real}. Obtaining the estimated load angle δ_{n,est} from the formula (3), to then calculate the frequency of the voltage set-point f_{e,n}, has been shown in FIG. 3B, specifically in steps 211-214 of block 21.

Alternatively, from the previous equation (2), the sine of the estimated load angle δ_{n,est} can be obtained:

$${( sin ( {δ}_{n} ) )}_{est} = \frac{{P}_{n} \cdot {X}_{n}}{{E}_{n} \cdot {V}_{n}} \approx {( sin ( {δ}_{n} ) )}_{real} \qquad ( 4 )$$

wherein sin(δₙ) is the sine of the loading angle. As before, the sine of the estimated load angle (sin(δₙ))ₑₛₜ is approximately equal to the sine of the real load angle (sin(δₙ))ᵣₑₐₗ.

Alternatively, from the previous equation (2), the conductance of the converter can be obtained:

$${G}_{n} = \frac{{P}_{n}}{{E}_{n} \cdot {V}_{n}} \approx \frac{1}{{X}_{n}} \cdot sin ( {δ}_{n , real} ) \qquad ( 5 )$$

wherein Gₙ is the conductance of the electronic converter 10ₙ. As in the previous case, the obtained conductance is approximately the real conductance.

An advantage of directly using the load angle δₙ, or a parameter dependent on the load angle, is that the system is linearised, so that the droop dynamics is independent from the relationship between current and voltage.

Returning to the block 21 of FIG. 3B, in the step 211, from the exchanged active power Pₐ and the effective value of voltage Vₙ, the active current I_{act,n} is calculated which enables, using the previously calculated effective value of imposed voltage Eₙ, the conductance Gₙ of the electronic converter 10ₙ to be obtained (step 212). With this, in the step 213, the sine of the load angle is obtained, sin(δₙ), since the reactance of the filter Xₙ is known. From the sine of the load angle, the load angle δₙ is obtained (step 214).

After obtaining the load angle δₙ, a filtering step 25 can optionally be applied. For example, a low pass filter can be applied. After optional filtering, from the load angle δₙ a frequency droop method (δ-f droop) can be applied (step 26) to obtain the frequency of the voltage set-point f_{e,n} which must be generated by the electronic converter. The applied droop can be a slope line m_{S}_{ₙ}, wherein the slope m_{S}_{ₙ} represents a droop coefficient of the load angle, or any other mathematical function. In one possible embodiment, the δ-f droop method imposes the following linear relationship on each electronic converter:

$${f}_{en} = {f}_{0 , n} - {m}_{{δ}_{n}} \cdot {δ}_{n}$$

wherein f_{0,n} is the frequency when there is no load on the system (base frequency around 50 (or 60) Hz and m_{S}_{ₙ} is a droop coefficient of the load angle. The droop coefficient m_{S}_{ₙ} can be calculated from the following equation:

$${m}_{{δ}_{n}} = \frac{{M}_{δ}}{{δ}_{n , nom}} = {M}_{δ} \cdot \frac{{V}_{nom , n}^{2}}{{P}_{nom , n} \cdot {X}_{nom , n}}$$

wherein M_{δ} is the droop coefficient per sine unit of load angle and δ_{n,nom} is the rated (nominal) load angle calculated from the rated (nominal) values of the converter X_{nom,n}, P_{nom,n} and V_{nom,n}. The coefficient M_{δ} represents the maximum desired frequency variation under normal operating conditions. In the case of several converters in parallel (for example, FIG. 1B), depending on the situation and circumstances, the coefficient M_{δ} can have the same value in all the electronic converters connected in parallel, or it can take different values for some or all electronic converters. It usually takes the same value in all converters connected in parallel. Preferably Vₙₒₘ is the same in all the electronic converters connected in parallel. In this case, the difference between the different δ_{n,nom} of each converter is due to the differences between the X_{nom,n} and P_{nom,n} of each of them. In this way, it is guaranteed that the distribution of load between electronic converters is proportional to the rated (nominal) power of each of them. Thus, for example, with regard to the percentage of power delivered with respect to the rated power thereof, if the system made up of several converters in parallel is to operate at 80%, each one of the converters is intended to operate at approximately 80% (compared to a situation where some operate at 60% and others at 100%). In short, by monitoring the slope of each frequency droop control, all the converters operate in a similar manner.

Returning to FIG. 3B, the output of the block 21 may alternatively be the output of the step 213, i.e., the sine of the load angle, sin(δₙ). From this sine, the step 26 of frequency droop (δ-f droop) can be applied to obtain the reference frequency f_{e,n}, from said sine. For example:

$${f}_{en} = {f}_{0 , n} - {m}_{{δ}_{n}} \cdot sin ( {δ}_{n} )$$

Also alternatively, the output of the block 21 may be the output of the step 212, i.e., the conductance Gₙ of the electronic converter 10ₙ. From the conductance, the step 26 of frequency droop (δ-f droop) can be applied to obtain the reference frequency f_{e,n}. For example:

$${f}_{en} = {f}_{0 , n} - {m}_{{δ}_{n}} \cdot {G}_{n}$$

Obtaining the frequency of the voltage set-point f_{e,n} that must be generated by the electronic converter, and the subsequent obtaining of said set-point (or set-points, in the three-phase case), which is described below, is periodically executed, according to a certain execution period. In general, the control method or algorithm of FIG. 4 is executed according to an execution period.

The function (e.g., linear function) used by the droop step 26 may be predetermined or may be dynamically modified to vary the power supplied by each converter. In the event of dynamic modification, the slope or the offset of the linear function can be modified. Normally this function is controlled at a higher level, i.e., in a slower manner with respect to the execution period of the control method. Similarly, the function used by the droop step 26 may be predetermined or may be dynamically modified to vary the frequency generated by each converter. When the function used by the droop step 26 is dynamically modified, the modification may be controlled by an external control unit, not illustrated.

As has been observed, to obtain the load angle δₙ of each converter 10ₙ, or of a load angle-dependent parameter, local measurements of the respective converter are used. In other words, no data is needed from other converters in the set of converters connected in parallel, if any (FIG. 1B). In other words, in this sense, each converter is autonomous with respect to the rest, without exchanging variables between them.

As shown in FIG. 4, the frequency of the voltage set-point f_{e,n} obtained by the proposed frequency droop method (step 42) is used to calculate a voltage set-point that must be generated by the electronic converter (step 44).

Thus, at each instant, the voltage set-point(s) V_{cons} that must be generated by the electronic converter is/are calculated, depending on whether it is a single-phase or three-phase converter, so that the phase (or each phase) behaves as an alternating voltage source with certain amplitude and phase values.

As shown in FIG. 4, in a first step of the control method (block 41), at least one variable to be used in a subsequent droop is calculated from the instantaneous current measurement in and instantaneous voltage measurement vₙ of the converter 10ₙ (or the instantaneous currents i_{r,n} i_{s,n} i_{t,n} and voltages v_{r,n} v_{s,n} v_{t,n} of each phase). In a possible embodiment, the droop variable calculation block 41 represents the variable(s) required to perform the frequency droop 42. As explained above (FIGS. 3A-3B), to perform the frequency droop 42, the load angle δₙ of each converter or a load angle-dependent parameter (for example, the sine of the load angle of the converter or the reactance of the corresponding output filter) is required. Note that, in this case, the block 41 substantially corresponds to the blocks 20 and 21 of FIGS. 3A-3B. The voltage set-point V_{cons} (or set-points, in the case of a three-phase converter), which is the voltage that the electronic converter must generate in the phase (single-phase) or each phase (three-phase), is normally obtained from a frequency value (frequency f_{e,n} obtained in the droop step 42) and by an amplitude value. To obtain this amplitude value of the voltage set-point V_{cons} preferably, the control method includes, in addition to the frequency droop 42, a voltage droop 43, which provides said amplitude V_{droop,n} of the voltage set-point. In this case, the droop variable calculation block 41 additionally represents the variable(s) required to perform the voltage droop 43. For example, to perform the voltage droop 43 the reactive power Q_{react,n} or the reactive current I_{react,n} can be used. The voltage droop method 43 to obtain the reference voltage V_{droop,n} falls outside the scope of the present disclosure.

A person skilled in the art will understand that the calculation of variables 41 does not have to be performed together, but that the variable(s) for the frequency droop 42 and for the voltage droop 43 can be independently calculated.

In addition, both to obtain the variable(s) required for the execution of the frequency droop 42 (such as the load angle variable or a parameter dependent on the same) and to obtain the variable(s) required for the execution of the voltage droop 42 (such as the reactive power or the reactive current), data (variables or parameters) of the converter 10ₐ itself are locally used, without the need for data intervention of other converters. After the frequency droop 42, which provides the frequency of the voltage set-point fₑ,n as explained in FIGS. 3A-3B, and preferably also after the voltage droop 43, which provides the amplitude of the voltage set-point V_{droop,n}, the voltage set-point (or voltage set-points in the three-phase case) V_{cons}, is obtained (block 44), which is defined by said frequency value f_{e,n} and preferably also the amplitude value V_{droop,n}. Thus, the voltage set-point in each phase is determined by the set-point amplitude and set-point frequency previously obtained.

Preferably, obtaining the voltage set-points (block 44) at each instant is performed from the amplitude V_{droop,n} of the voltage set-point and an angle obtained, for example, by integrating the frequency f_{e,n}.

And optionally, from these voltage set-points V_{cons}, and from the instantaneous current measurement in and instantaneous voltage measurement vₙ of the converter 10ₙ (or the instantaneous currents i_{r,n} i_{s,n} i_{t,n} and voltages v_{n,r,n} v_{s,n} v_{t,n} of each phase, in the three-phase case), at each instant (execution cycle), a voltage control block 45 calculates the reference voltage e_{v,n} that must be imposed on the phase of the single-phase converter (or the reference voltages e_{r,v,n}, e_{s,v,n}, e_{t,v,n} that must be imposed on each phase of the three-phase converter), in order to generate the voltage set-point(s), so that the corresponding phase behaves as a voltage source, in particular as an alternating voltage source with certain amplitude and phase values. In other words, the step 45 returns the voltages that must be applied to obtain the aforementioned voltage set-points. In general, three reference voltages are shown e_{r,v,n}, e_{s,v,n}, e_{t,v,n} corresponding to a three-phase system (note that if the converter is single-phase, the reference voltage will be e_{v,n}). The method carried out by the voltage control block 45 falls outside the scope of the present disclosure. By way of non-limiting example, the voltage control block 45 can calculate the reference voltages e_{r,v,n}, e_{s,v,n}, e_{t,v,n} by means of open-loop voltage control, control of the instantaneous voltage value on the alpha and beta axes or on the d and q axes, among others. The selected control voltage e_{r,v,n}, e_{s,v,n}, e_{t,v,n} can then be applied to the corresponding phase of the conversion step of the electronic converter 10ₙ.

Optionally, a current limitation or control loop is also executed at each instant, implemented in a current control block 46 such as the one shown for example in FIG. 4, which calculates the voltages that must be imposed (or should be generated) in each phase e_{r,n}, e_{s,n}, e_{t,n} (if the converter is three-phase) or in phase eₙ (if the converter is single-phase) by the electronic converter 10ₙ so that the current does not exceed a defined maximum value, for example in the event of current limitation, presence of excess load, voltage dips or short circuits. The current controller 46 also falls outside the scope of the present disclosure. By way of example, the current controller 46 may be implemented by an internal current loop, or by hysteresis current limiting, or by emulating an impedance, or by any other method of the state of the art. The selected control voltage can then be applied to the corresponding phase of the conversion step of the electronic converter, such that the current in that phase is comprised between a predefined upper current limit and a predefined lower current limit.

In this way, under normal operating conditions, the voltage generated by the inverter in each phase is equal to the voltage eₙ, e_{r,n}, e_{s,n}, e_{t,n} calculated by the voltage control 45. However, in faulty or overload situations, there will always be instants in which the reference voltage, of one or several phases, of the current control 46 is more restrictive than that provided by the voltage control 45. In these cases and in these phases, the voltage generated by the electronic converter 10ₙ is equal to the reference voltage provided by the current control 46, which ensures current control at the defined maximum value at the expense of a reduction in the output voltage.

The implementation of the control proposed in the present disclosure is applicable to the phase of a single-phase electronic converter, taking into account that in a single-phase converter it is only required to generate a reference voltage by the voltage control 45 (or in its case, current limitation 46), or to each of the phases of a three-phase electronic converter. When an installation includes a plurality of electronic converters arranged in parallel (FIG. 1B), the control method is simultaneously executed for all of them. However, advantageously, as a consequence of the frequency droop control method of the disclosure (δ-f droop), the control of each converter is performed from local parameters, of the converter itself. Thus, communication between various converters to share data is prevented. The proposed method for controlling electronic converters operating in parallel guarantees the synchronisation of electronic converters, both under normal operating conditions and in the presence of excess loads, voltage dips or short circuits in the microgrid, without requiring the introduction of communication between electronic converters. The electronic converters remain synchronised at the output of the same when they are connected to any element at the input thereof, whether it is, for example, an energy source or a storage system, or a combination of both, and/or when at the output thereof they are connected to the electricity grid or to a system isolated from the electricity grid.

The calculations are carried out in a control unit comprising processing means, for example, in a processor.

As explained, the electronic converter 10ₙ intends to impose the voltage set-points V_{cons} obtained according to the proposed method (step 44). However, it may occur that the desired voltage cannot be imposed, due to, for example, the action of the current limitation. Therefore, during the execution of the method, or after the application thereof, the load angle δₙ (or a parameter dependent on the same) of one or more converters can be corrected to compensate for the phase shift between the voltage set-point obtained (step 44) and the voltage finally imposed (output of step 45 or, where appropriate, step 46) by the electronic converter before the filter thereof.

For example, during the execution of the method, or after the application thereof, the load angle δₙ (or a parameter dependent on the same) of one or more converters can be corrected to compensate for the phase shift introduced by current limitation between the voltage set-point and the voltage finally imposed by the electronic converter before the filter thereof.

The control method does not require the exchange of variables between converters. Specifically, to obtain the reference frequency of each converter 10ₙ, which in turn depends on the load angle δₙ of each converter, or of a load angle-dependent parameter, local measurements of the respective converter are used.

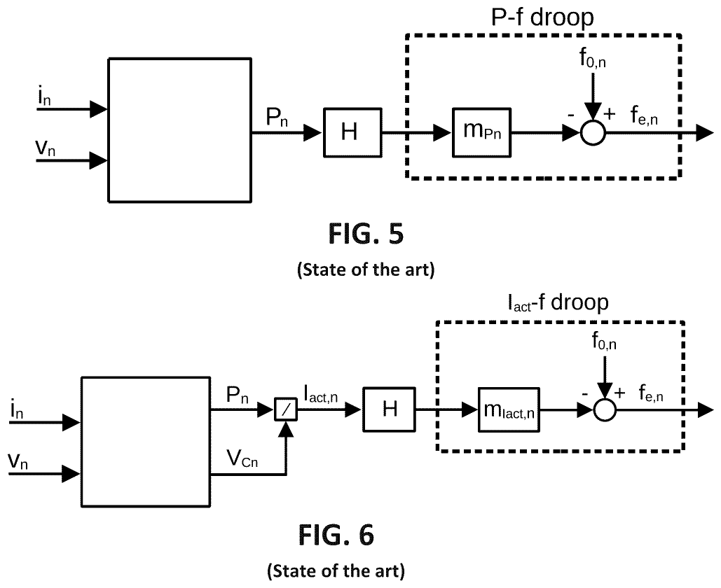

In order to show the advantages of the δ-f droop method proposed in the present disclosure, compared to conventional P-f droop and I_{act}-f droop methods, the control scheme of FIG. 4 has been simulated for the case, by way of example, of two electronic converters in parallel. The results obtained can be extended to a configuration with a larger number of electronic converters connected in parallel. FIGS. 5 and 6 schematically show the performance of the conventional P-f droop and I_{act}-f droop, respectively. FIG. 3B schematically shows the performance of the δ-f droop of the disclosure used in the simulation. In all three cases, the same low-pass digital filter H (block 25 in FIG. 3B) has been used to filter the measurements of Pₙ, I_{act,n} and δₙ.

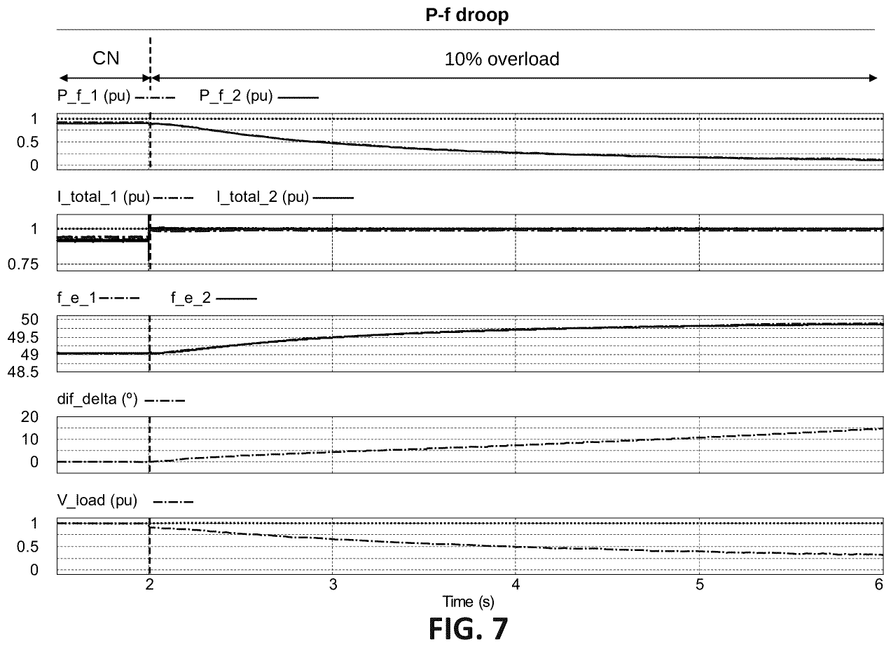

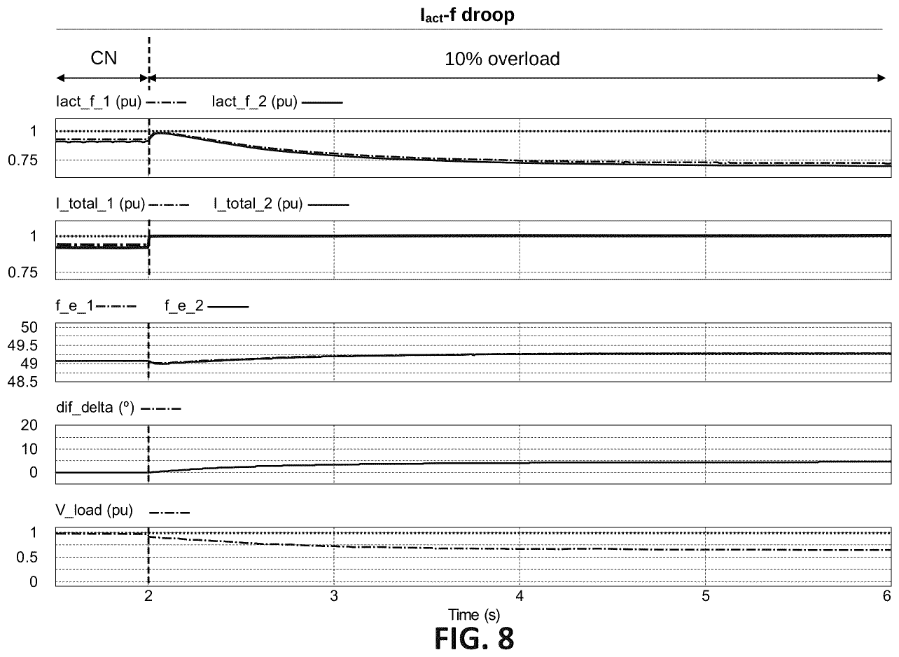

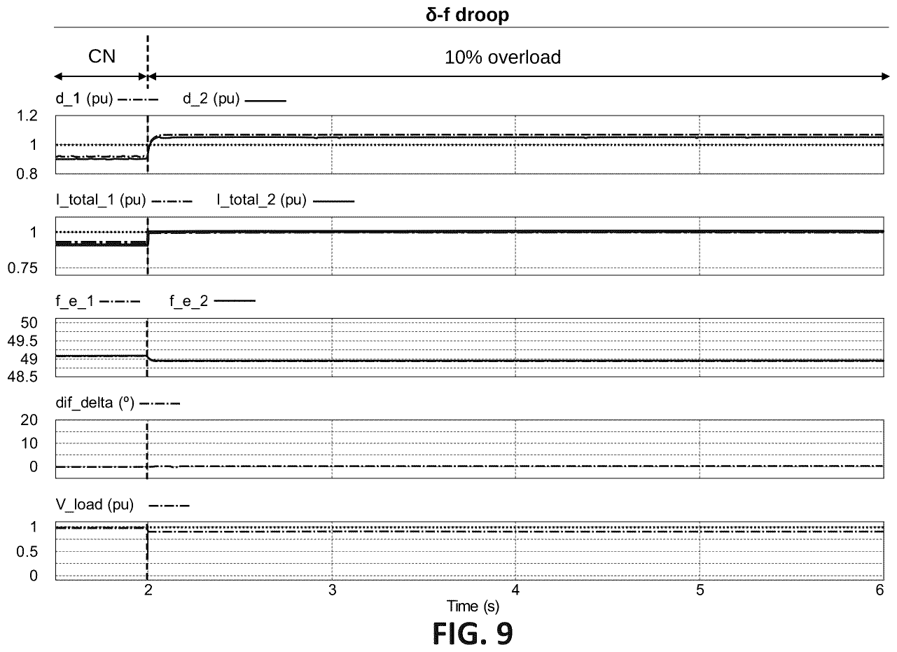

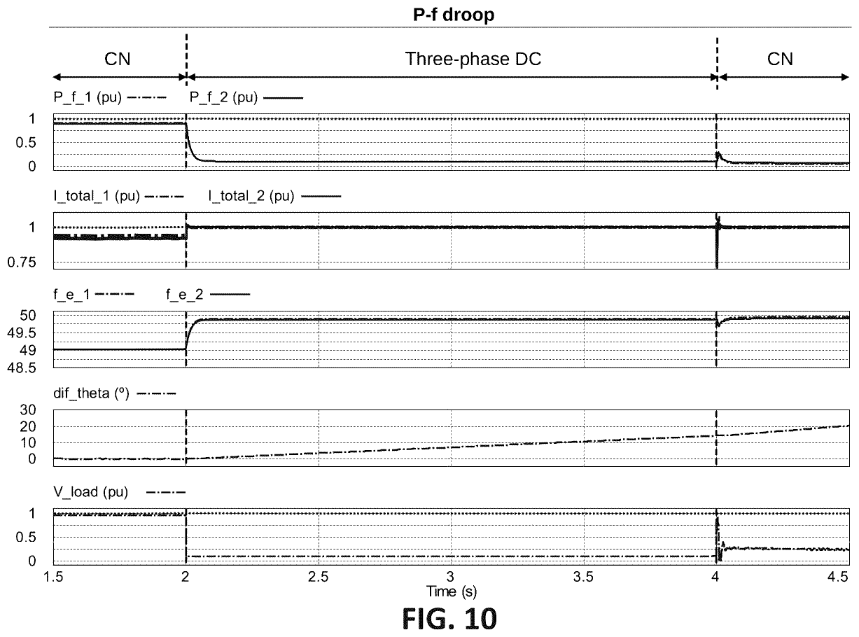

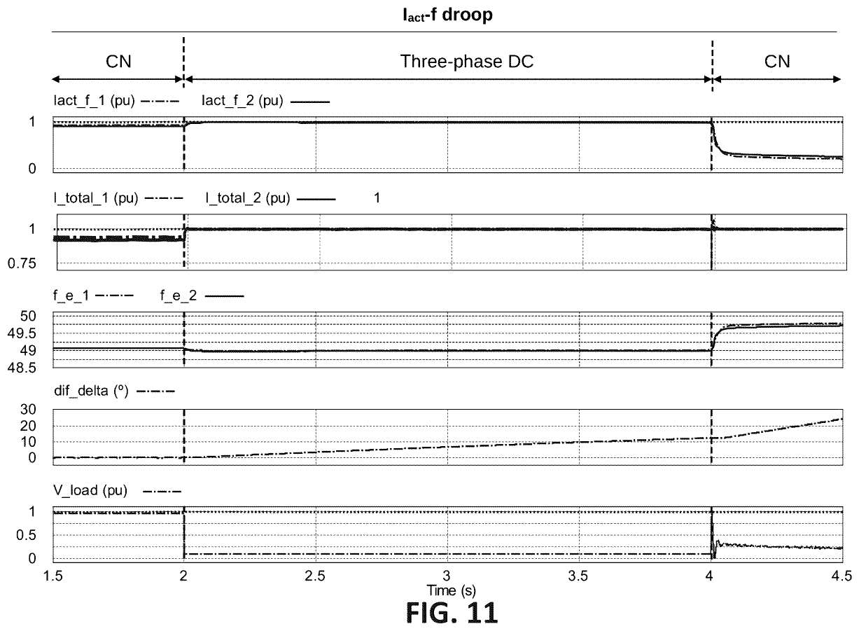

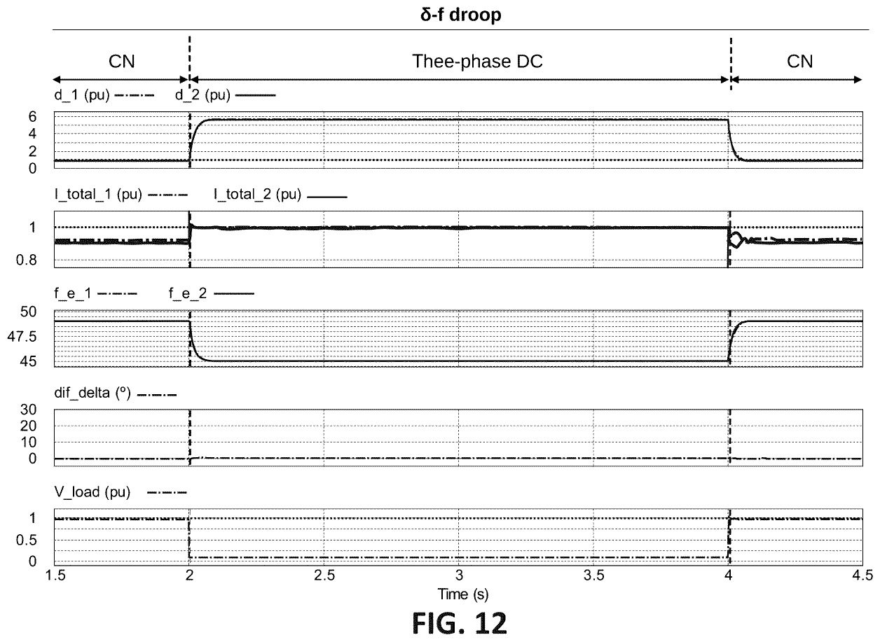

The system has been simulated with the three frequency droop control methods for two different situations wherein it is necessary to limit the current of the inverters:
1. 10% overload, i.e., connection of a load the Iₙₒₘ of which exceeds the total rated (nominal) current of the two electronic converters by 10%. The results obtained are shown in FIG. 7 for the P-f droop, in FIG. 8 for the I_{act}-f droop and in FIG. 9 for the proposed method with δ-f droop.
2. Three-phase short circuit with a DC voltage, U_{DC}=10%, and a duration of 2s. The results obtained are shown in FIG. 10 for the P-f droop, in FIG. 11 for the _{act}-f droop and in FIG. 12 for the proposed method with δ-f droop.

In FIGS. 7-12, the evolution of the variables of each of the two electronic converters is shown for each case. The first graph of each case shows the filtered variables per unit (pu, values per unit) used in performing the frequency droop (P in FIGS. 7 and 10, I_{act} in FIGS. 8 and 11 and δ in FIGS. 9 and 12) in order to compare the evolution of each variable depending on the method used. The rest of the graphs show the same variables in the three cases. The second graph shows the evolution of the effective values of the currents in pu, the third shows the evolution of the generated frequencies (f_{e,i}), the fourth shows the phase shift between the two electronic converters 1 (dif_delta=S₁-S₂) and the fourth shows the total amplitude of the voltage in the load in pu.

In all cases, initially, the two electronic converters are supplying an isolated set of loads of 90% of the total rated (nominal) current and, since limiting the current references is not required, the electronic converters are working under normal operating conditions (CN). In this operating mode, the load distribution is almost equal and the small difference between the load levels of each inverter is due to the fact that possible measurement errors (±0.5%) that introduce offsets in the calculation of Pₙ, I_{act,n} and δₙ have been modelled. In this way, the phase shift between inverters (dif_delta) is kept close to 0, so there is no current recirculation between inverters and all the current provided by them is delivered to the load. Since limiting the current is not required, the inverters behave as voltage sources and the load voltage is equal to the rated voltage.

Considering the results obtained in an overload situation with the P-f droop (FIG. 7), it can be seen how the currents increase at the beginning, causing the current limitation to act to keep them equal to their rated value. As a consequence, the voltage decreases and the active powers P₁ and P₂ also decrease. This causes the P-f droop to increase the frequency generated by the inverters instead of decreasing it and the phase shift between them begins to increase, i.e., the inverters begin to desynchronise. Due to this, current begins to recirculate between the inverters, so the current delivered to the load is less than the total current of the same. This causes a decrease in the load voltage and, therefore, also in the active powers P₁ and P₂, making the situation even worse. In short, the P-f droop does not provide stable behaviour and does not enable the inverters to remain synchronised under these conditions.

In the case of overload with the I_{act}-f droop shown in FIG. 8, it is observed how at the beginning the active currents I_{act,1} and I_{act,2} increase and remain close to the rated value of the current. This causes the frequencies generated by the inverters to remain practically constant instead of decreasing and the phase shift between inverters begins to increase, although more slowly than with the P-f droop. As a consequence, current begins to recirculate between the inverters, causing a decrease in load voltage. In this case, as the current depends less than the power on the voltage, a stable operating point is achieved. However, even though the inverters remain synchronised, the response provided by the I_{act}-f droop is not suitable either, since a high phase shift between inverters is obtained and the load voltage drops much more than necessary.

Regarding the results obtained with the δ-f droop shown in FIG. 9, the behaviour of the system when the overload occurs is different from that obtained with the P-f droop and I_{act}-f droop. When the overload is introduced, the load angles δ₁ and δ₂ increase above the rated value. In this way, the frequencies generated by the inverters decrease and the inverters remain synchronised without any phase shift appearing between them. As a consequence, no current recirculates between inverters, but all the current provided by them is delivered to the load and therefore the voltage thereof remains equal to 0.9 pu.

Finally, the behaviour of the system in the presence of a three-phase short-circuit with short-circuit voltage U_{DC}=10% is analysed. When the short circuit occurs, FIG. 10 shows that the active powers are reduced while FIG. 11 shows that the active currents remain practically constant. As a consequence, the droops do not impose the frequency reduction that would be required, giving rise to a difference in dif_delta angles that increases, i.e., causing a desynchronisation of the inverters. Therefore, when the short circuit is dissipated in the second 4, the large phase shift between inverters causes the current limitation to enter again and the voltage not to be recovered. On the contrary, the behaviour with the δ-f droop is very different, as shown in FIG. 12. When the short circuit occurs, the load angles δ₁ and δ₂ increase considerably in relation to the value. In this way, the δ-f droop maintains the same behaviour as under normal operating conditions, and the phase shift between inverters also remains close to zero during the short circuit. This enables the voltage in the load to recover quickly when the short circuit is cleared and current limiting is not required.

The electronic converter to which the method of the present disclosure is applied therefore functions as a voltage source. That is, the electronic converter is controlled at the output thereof as an alternating voltage source.

In this text, the term “comprises” and its derivations (such as “comprising”, etc.) must not be understood in an exclusive sense, i.e., these terms must not be interpreted as excluding the possibility of what is described and defined including further elements, steps, etc.

In the context of the present disclosure, the term “approximately” and terms of the family thereof (such as “approximate”, etc.) should be interpreted as indicating values very close to those that accompany said term. That is, a deviation within reasonable limits from an exact value should be accepted, because a person skilled in the art will understand that such a deviation from the indicated values may be unavoidable due to measurement inaccuracies, etc. The same applies to the terms “some”, “around” and “substantially”.

The disclosure is obviously not limited to the specific embodiment(s) that have been described, rather it also covers any variation that may be considered by any person skilled in the art (for example, in relation to the choice of materials, dimensions, components, configuration, etc.), within the general scope of the disclosure as defined in the claims.

1. A method for controlling an electronic converter, comprising:
for each of the phases of the electronic converter, measuring an instantaneous current and an instantaneous voltage of the electronic converter;
calculating, from the current measurements and voltage measurements an active power exchanged by the electronic converter and an effective value of voltage of the electronic converter;
calculating an effective value of voltage imposed by the conversion step of the electronic converter;
the method including the following steps:
obtaining the load angle or a load angle-dependent parameter from the active power, the effective value of voltage and the effective value of imposed voltage,
calculating the frequency of a voltage set-point that must be generated by the electronic converter from the load angle or the load angle-dependent parameter, and
obtaining the voltage set-point that must be generated by the electronic converter from the frequency.

2. The method of claim 1, wherein the frequency of the voltage set-point that must be generated by the electronic converter, is obtained by applying a frequency droop to the load angle or to the load angle dependent parameter.

3. The method of claim 2, wherein the load angle or the load angle-dependent parameter is filtered before applying the frequency droop.

4. The method of claim 2, wherein the applied frequency droop follows a linear function.

5. The method of claim 1, wherein the measured voltage has been measured at the terminals of a capacitor of an output filter of each phase of the electronic converter.

6. The method of claim 1, wherein the measured voltage has been measured at the output of the electronic converter.

7. The method of claim 1, wherein the measured voltage has been obtained by measuring the line voltage.

8. The method of claim 1, wherein the load angle or the load angle-dependent parameter is obtained from the following equation:
$${P}_{n} = \frac{{E}_{n} \cdot {V}_{n}}{{\vert {\vec{Z}}_{n} \vert}^{2}} \cdot {X}_{n} \cdot sin ( {δ}_{n} ) + \frac{{V}_{n}}{{\vert {\vec{Z}}_{n} \vert}^{2}} \cdot {R}_{n} \cdot ( {E}_{n} \cdot cos ( {δ}_{n} ) - {V}_{n} )$$
wherein Pₙ is the active power exchanged by the electronic converter, Vₙ is the effective value of voltage of the electronic converter, Eₙ is the effective value of voltage imposed by the conversion step of the electronic converter and \vec{Zₙ}=Rₙ+j Xₙ is the impedance of the filter of the electronic converter.

9. The method of claim 1, wherein the load angle or the load angle-dependent parameter is obtained from the following equation:
$${P}_{n} = \frac{{E}_{n} \cdot {V}_{n}}{{X}_{n}} \cdot sin ( {δ}_{n} )$$
wherein Pₙ is the active power exchanged by the electronic converter, Vₙ is the effective value of voltage of the electronic converter, Eₙ is the effective value of voltage imposed by the conversion step of the electronic converter and Xₙ is the reactance of the filter of the electronic converter.

10. The method of claim 1, further comprising the step of applying a voltage droop to obtain an amplitude value of the voltage set-point that must be generated by the electronic converter (10ₙ), and wherein said voltage set-point is obtained from said frequency and from the amplitude value.

11. The method of claim 10, wherein said voltage droop uses reactive power or reactive current.

12. The method of claim 1, further comprising, once the voltage set-point has been obtained, the step of applying a voltage control step to determine a voltage that must be imposed by the electronic converter to get that voltage set-point.

13. The method of claim 12, wherein the voltage control step implements a voltage control in alpha and beta axes, or a voltage control in dq axes, or an open-loop voltage control.

14. The method of claim 1, further comprising a current limiting step.

15. The method of claim 14, further comprising correcting the load angle or the load angle-dependent parameter, to compensate for the phase shift introduced by the current limitation between the voltage set-point and the voltage imposed by the electronic converter.

16. The method of claim 1, further comprising correcting the load angle or the load angle-dependent parameter, to compensate for any possible phase shift between the voltage set-point and the voltage imposed by the electronic converter.

17. The method of claim 1, wherein the function used to calculate the frequency of a voltage set-point can be predetermined or can be dynamically modified by an external control unit.

18. The method of claim 1, applied to a plurality of electronic converters connected in parallel.

19. The method of claim 1, applied to one or more single-phase electronic converters.

20. The method of claim 1, applied to one or more three-phase electronic converters.

21. The method of claim 1, wherein the method is repeated at time instants that are marked according to a clock frequency.

22. A system for controlling an electronic converter to carry out the method described in claim 1, the system comprises:
measuring means configured for an instantaneous current and an instantaneous voltage of the electronic converter;
calculating means configured for:
calculating, from the current measurements and voltage measurements: an active power exchanged by the electronic converter and an effective value of phase voltage of the electronic converter;
calculating an effective value of voltage imposed by the conversion step of the electronic converter;
obtaining the load angle or a load angle-dependent parameter from the active power, the effective value of voltage and the effective value of imposed voltage;
calculating the frequency of a voltage set-point that must be generated by the electronic converter from the load angle or the load angle-dependent parameter; and
obtaining the voltage set-point that must be imposed in the electronic converter from said frequency.

23. The control system of claim 22, further comprising a voltage controller.

24. The control system of claim 22, further comprising a current controller.
